(19) United States
(12) Patent Application Publication
(10) Pub. No.: US 2016/0046497 A1
(43) Pub. Date: Feb. 18, 2016

(54) REACTOR SCHEME IN ANDRUSSOW PROCESS

(71) Applicants: INVISTA NORTH AMERICA S.A R.L., Wilmington, DE (US); INVISTA TECHNOLOGIES S.A.R.L., St. Gallen (CH)

(72) Inventors: Stewart FORSYTH, Wilmington, DE (US); Aiguo LIU, Elk Grove, IL (US); Martin J. RENNER, Hallettsville, TX (US); Brent J. STAHLMAN, Victoria, TX (US)

(73) Assignee: INVISTA NORTH AMERICA S.A R.L., Wilmington, DE (US)

(21) Appl. No.: 14/742,050

(22) PCT Filed: Dec. 12, 2013
(86) PCT No.: PCT/US13/74524

§ 371 Date: Jun. 17, 2015

Related U.S. Application Data
(60) Provisional application No. 61/738,884, filed on Dec. 18, 2012.

(51) Int. Cl. C01C 3/02

(52) U.S. Cl. CPC C01C 3/0212

(57) ABSTRACT

A process for the production of hydrogen cyanide comprises feeding a reaction mixture feed to a plurality of primary reactors each comprising a catalyst bed comprising platinum, wherein the reaction mixture feed comprises gaseous ammonia, methane, and oxygen gas, determining whether a percent yield of hydrogen cyanide in any of the plurality of primary reactors is at or below a threshold, identifying one or more suboptimal reactors amongst the plurality of primary reactors when the percent yield of hydrogen cyanide in any of the plurality of primary reactors is at or below the threshold, and supplementally feeding the reaction mixture feed to one or more supplementary reactors when the one or more suboptimal reactors are identified, wherein each of the one or more supplementary reactors comprises a catalyst bed comprising platinum. The supplemental feeding can be performed in place of the feeding of the reaction mixture feed to the one or more suboptimal reactors or in addition to the feeding of the reaction mixture feed to the one or more suboptimal reactors. The overall process is sufficient to maintain an overall measured hydrogen cyanide production rate amongst the one or more supplementary reactors and the primary reactors that is within a desired overall hydrogen cyanide production rate range.

### CROSS-REFERENCE TO RELATED APPLICATION

This application claims the benefit of priority to U.S. Provisional Patent Application Ser. No. 61/738,884 entitled “REACTOR SCHEME IN ANDRUSSOW PROCESS,” filed Dec. 18, 2012, the disclosure of which is incorporated herein in its entirety by reference.

### TECHNICAL FIELD

The present disclosure is directed to a reactor scheme for the Andrussow process for the production of hydrogen cyanide (HCN) from methane, ammonia, and oxygen.

### BACKGROUND

The Andrussow process is used for gas phase production of hydrogen cyanide (HCN) from methane, ammonia, and oxygen over a platinum or platinum alloy catalyst. Filtered ammonia, natural gas and air are fed into a reactor and heated to about 800° C. to about 2,500° C. in the presence of a catalyst that comprises platinum or a platinum alloy. The methane can be supplied from natural gas, which can be further purified. Hydrocarbons having two carbons, three carbons, or more can be present in natural gas. While air can be used as a source of oxygen, the reaction can also be carried out with oxygen-enriched air or undiluted oxygen (e.g., an oxygen Andrussow process). Heat from the reactor effluent can be recovered in one or more waste heat boilers, which also cools the reactor effluent to a desired temperature. The reactor off-gas containing HCN can be sent through an ammonia absorption process to remove un-reacted ammonia. This can be accomplished by contacting with an ammonium phosphate solution, phosphoric acid or sulfuric acid to remove the ammonia. From the ammonia absorber the product off-gas can be sent through an HCN absorber where cold water can be added to entrain the HCN. The HCN-water mixture can be sent to a cyanide stripper where waste can be removed from the liquid. In addition, the HCN-water mixture can be sent through a fractionator to concentrate the HCN before the product is stored in tanks or used as a feedstock.

Many HCN production facilities that incorporate the Andrussow process include a plurality of reactors operating in parallel to increase the overall production rate of the HCN. During operation of these multi-reactor Andrussow systems, the catalyst in one or more of the reactors can unpredictably begin operating at suboptimal conversion yields, such as when a catalyst bed is reaching the end of its life. Such an unpredictable suboptimal operation of one or more of the catalyst beds can result in a suboptimal conversion rate of the reactants being fed to the system and a suboptimal yield of HCN, either because of the suboptimal operation of the catalyst bed or beds or because the suboptimal reactor or reactors are unexpectedly shut down during a time when the facility was expected to be operating at full capacity.

Not only can a suboptimal reactor cause the overall conversion rate and yield to be below a desired rate or yield, but the suboptimal reactor can cause an inconsistent flow and concentration of HCN in the product stream that is sent to subsequent purification and processing portions of the facility. An inconsistent flow and concentration of HCN that is fed to the purification and processing systems can result in inconsistent swings in the final production rate of the HCN product. Non-uniform operation can also result in less economical operation of the downstream operations. The swings in the production rate or concentration of HCN can also result in quality concerns. For example, swings in the HCN production rate can result in a swing in production rates in downstream consumers.

Some additional difficulties can be encountered when using an oxygen-enriched Andrussow process or an oxygen Andrussow process as compared to an air Andrussow process. In an air Andrussow process, the oxygen feed stream comprises air, having an oxygen content of about 20.95 mol % oxygen. Oxygen-enriched or oxygen Andrussow processes have an oxygen-containing feed stream having an oxygen content that is greater than that in air, such as about 21 mol % oxygen to about 30 mol % oxygen for an oxygen-enriched Andrussow process or about 26 mol % oxygen to about 100 mol % oxygen for an oxygen Andrussow process. For example, with a more concentrated oxygen content in the reactant feed, the process tends to proceed in a more concentrated fashion such that the process can tend to generate higher concentrations of all products, including byproducts. The equipment in an oxygen-enriched Andrussow process or an oxygen Andrussow process can, therefore, be more susceptible to build-up of impurities, which can be more easily flushed from the system in an air Andrussow process. The greater rate of byproduct buildup can lead to corrosion of the equipment or more frequent shutdown for the oxygen-enriched Andrussow process or the oxygen Andrussow process compared to the air Andrussow process. Moreover, because the reagents and products in an oxygen-enriched Andrussow process or an oxygen Andrussow process can be more concentrated, the system can be more sensitive to variations in concentration of reagents than in an air Andrussow process. For example, a local variation in reagent concentration can result in local hot spots within the catalyst bed, which can reduce the life of the catalyst compared to an air Andrussow process. An oxygen-enriched or oxygen Andrussow process is more sensitive to changes in the heating value of the feed gas; therefore, small variations in the composition of the feed stream can cause greater temperature fluctuations in the reactor than would be observed for similar feed stream compositions in an air Andrussow process. In addition, variations in the concentration or flow rate of reagents in an oxygen-enriched or oxygen Andrussow process can cause larger differences in the overall efficiency of the process as compared to an air Andrussow process.

Various aspects of HCN production are described in the following articles: Eric. L. Crump, U.S. Environmental Protection Agency, Office of Air Quality Planning and Standards, Economic Impact Analysis For the Proposed Cyanide Manufacturing NESHAP (May 2000), available online at http://nepis.epa.gov/Exe/ZyPDF.cgi?Dockey=P100AHG1.PDF, is directed toward the manufacture, end uses, and economic impacts of HCN; N. V. Trusov, Effect of Sulfur Compounds and Higher Homologues of Methane on Hydrogen Cyanide Production by the Andrussow Method, Rus. J. of Applied Chemistry, Vol. 74, No. 10, pp. 1693-97 (2001), is directed toward the effects of unavoidable components of natural gas, such as sulfur and higher homologues of methane, on the production of HCN by the Andrussow process; Clean Development Mechanism (CDM) Executive Board, United Nations Framework Convention on Climate Change (UNFCCC), Clean Development Mechanism Project Design Document Form (CDM PDD), Ver. 3, (Jul. 28, 2006), available online at http://cdm.unfccc.int/Reference/PDDs_Forms/PDDs/PDD_form04_v03_{—}2.pdf, is directed toward the production of HCN by the Andrussow process; and Gary R. Maxwell et al., Assuring process safety in the transfer of hydrogen cyanide manufacturing technology, J. of Hazardous Materials, Vol. 142, pp. 677-84 (2007), is directed toward the safe production of HCN.

### SUMMARY

As noted above, problems with existing Andrussow systems can include suboptimal conversion in one or more reactors due to unexpected suboptimal catalyst activity, which can result in the need for unplanned or frequent catalyst replacement. Further, the suboptimal conversion due to poor catalyst activity can lead to unexpected swings in production rates of the entire Andrussow system. The present disclosure describes a system for producing hydrogen cyanide that can avoid or reduce the effect of suboptimal conversion rates to hydrogen cyanide in a multi-reactor Andrussow system due to the catalyst in one or more of the reactors operating at less than a desired activity or due to the changeover from an old catalyst to a new catalyst in a reactor. The system of the present disclosure includes the use of a supplemental reactor beyond the number of reactors that are needed to achieve the maximum rate of the plant in which the system is operating if all the reactors are operating at capacity. Upon detection of the suboptimal operation of a particular reactor, the supplemental reactor can be activated to replace or supplement the suboptimal reactor. The supplemental reactor can therefore quickly remedy the problem of suboptimal conversion and can provide for a more consistent and predictable rate of hydrogen cyanide production via the Andrussow process.

The present describes a process for the production of hydrogen cyanide. The process can include feeding a reaction mixture feed to a plurality of primary reactors each comprising a catalyst bed comprising platinum or a platinum alloy. The reaction mixture feed can include gaseous ammonia, methane, and oxygen gas. While feeding the reaction mixture feed, it can be determined whether a percent yield of hydrogen cyanide in any of the plurality of primary reactors is at or below a threshold and one or more suboptimal reactors amongst the plurality of primary reactors can be identified when the percent yield of hydrogen cyanide in any of the plurality of primary reactors is at or below the threshold. The reaction mixture feed can be supplementally fed to one or more supplementary reactors when the one or more suboptimal reactors are identified, wherein each of the one or more supplementary reactors includes a catalyst bed comprising platinum or a platinum alloy. Upon commencing the supplementally feeding, the reaction mixture feed can be discontinued to the one or more suboptimal reactors. The determining, the supplementally feeding, and the discontinuing can be sufficient to maintain an overall measured hydrogen cyanide production rate amongst the one or more supplementary reactors and the primary reactors, other than the one or more suboptimal reactors, which is within a desired overall hydrogen cyanide production rate range.

The present disclosure also describes a process for the production of hydrogen cyanide that includes feeding a reaction mixture feed to a plurality of primary reactors each comprising a catalyst bed comprising platinum or a platinum alloy. The reaction mixture feed can include gaseous ammonia, methane, and oxygen gas. While feeding the reaction mixture feed, it can be determined whether a percent yield of hydrogen cyanide in any of the plurality of primary reactors is at or below a threshold and one or more suboptimal reactors amongst the plurality of primary reactors can be identified when the percent yield of hydrogen cyanide in any of the plurality of primary reactors is at or below the threshold. The reaction mixture feed can be supplementally fed to the one or more supplementary reactors each comprising a catalyst bed comprising platinum or a platinum alloy. The supplemental feeding can be sufficient to maintain an overall measured hydrogen cyanide production rate in the one or more supplementary reactors and the plurality of primary reactors that is within a desired overall hydrogen cyanide production rate range.

The present disclosure also describes a system for the production of hydrogen cyanide. The system can include a plurality of primary reactors each comprising a catalyst bed comprising platinum or a platinum alloy, wherein the plurality of primary reactors is capable of providing for a first hydrogen cyanide production rate and one or more supplemental reactors each comprising a catalyst bed comprising platinum or a platinum alloy. A feed system can feed the reaction mixture feed to one or more reactors at a rate sufficient to provide for the first hydrogen cyanide production rate, wherein the reaction mixture feed can include gaseous ammonia, methane, and oxygen gas. A control system can be configured to determine whether a percent yield of hydrogen cyanide in any of the plurality of primary reactors is below a threshold, identify one or more suboptimal reactors with a percent yield of hydrogen cyanide below the threshold, initiate supplemental feeding of the reaction mixture feed to the one or more supplemental reactors, discontinue the reaction mixture feed to the one or more suboptimal reactors, and maintain an overall measured hydrogen cyanide production rate in the one or more supplementary reactors and the primary reactors other than the one or more suboptimal reactors within a desired overall hydrogen cyanide production rate range.

The present disclosure also describes a system for the production of hydrogen cyanide that can include a plurality of primary reactors each comprising a catalyst bed comprising platinum or a platinum alloy, wherein the plurality of primary reactors are capable of providing for a first hydrogen cyanide production rate, and one or more supplemental reactors each comprising a catalyst bed comprising platinum or a platinum alloy. A feed system can feed a reaction mixture feed to one or more reactors at a rate sufficient to provide for the first hydrogen cyanide production rate, wherein the reaction mixture feed can include gaseous ammonia, methane, and oxygen gas. A control system can be configured to determine whether a percent yield of hydrogen cyanide in any of the plurality of primary reactors is below a threshold, identify one or more suboptimal reactors amongst the plurality of primary reactors with a percent yield of hydrogen cyanide below the threshold, initiate supplemental feeding of the reaction mixture feed to the one or more supplemental reactors, and maintain an overall measured hydrogen cyanide production rate in the plurality of primary reactors and the one or more supplementary reactors within a desired overall hydrogen cyanide production rate range.

These and other examples and features of the present systems and methods will be set forth in part in the following Detailed Description. This Summary is intended to provide an overview of the present subject matter, and is not intended to provide an exclusive or exhaustive explanation. The Detailed Description below is included to provide further information about the present systems and methods.

### BRIEF DESCRIPTION OF THE FIGURES

FIG. 1 is flow diagram of an example process for the production of hydrogen cyanide via the Andrussow process.

FIG. 2 is a flow diagram of an example hydrogen cyanide synthesis system that can be included as part of the process of FIG. 1.

### DETAILED DESCRIPTION

The synthesis of hydrogen cyanide by the Andrussow method (see, for example, Ullmann's Encyclopedia of Industrial Chemistry, Volume 8, VCH Verlagsgesellschaft, Weinheim, 1987, pp. 161-162) can be carried out in the vapor phase over a catalyst that comprises platinum or platinum alloys, or other metals. Catalysts suitable for carrying out the Andrussow process were discovered and described in the original Andrussow patent, published as U.S. Pat. No. 1,934,838, and elsewhere. In Andrussow's original work, he disclosed that catalysts can be chosen from oxidation catalysts that are infusible (solid) at the working temperature of around 1000° C.; he included platinum, iridium, rhodium, palladium, osmium, gold or silver as catalytically active metals either in pure form or as alloys. He also noted that certain base metals, such as rare earth metals, thorium, uranium, and others, could also be used, such as in the form of infusible oxides or phosphates, and that catalysts could either be formed into nets (screens), or deposited on thermally-resistant solid supports such as silica or alumina.

In subsequent development work, platinum-containing catalysts have been selected due to their efficacy and to the heat resistance of the metal even in gauze or net form. For example, a platinum-rhodium alloy can be used as the catalyst, which can be in the form of a metal gauze or screen such as a woven or knitted gauze sheet, or can be disposed on a support structure. In an example, the woven or knitted gauze sheet can form a mesh-like structure having a size from 20-80 mesh, e.g., having openings with a size from about 0.18 mm to about 0.85 mm. A catalyst can comprise from about 85 wt % to about 95 wt % Pt and from about 5 wt % to about 15 wt % Rh, such as 85/5 Pt/Rh, 90/10, or 95/5 Pt/Rh. A platinum-rhodium catalyst can also comprise small amounts of metal impurities, such as iron (Fe), palladium (Pd), iridium (Ir), ruthenium (Ru), and other metals. The impurity metals can be present in trace amounts, such as about 10 ppm or less.

A broad spectrum of possible embodiments of the Andrussow method is described in German Patent 549,055. In one example, a catalyst comprising a plurality of fine-mesh gauzes of Pt with 10% rhodium disposed in series is used at temperatures of about 800 to 2,500° C., 1,000 to 1,500° C., or about 980 to 1050° C. For example, the catalyst can be a commercially-available catalyst, such as a Pt—Rh catalyst gauze available from Johnson Matthey Plc, London, UK, or a Pt—Rh catalyst gauze available from Heraeus Precious Metals GmbH & Co., Hanau, Germany.

This disclosure describes processes and systems for the production of hydrogen cyanide via the Andrussow process. In various embodiments, the processes and systems of the present disclosure can involve the reactor scheme of a multi-reactor Andrussow process where a chemical production plant is rated with a maximum production rate, such as via a governmental permit. A specific number of primary reactors can be sufficient to sustain the permitted rate or a desired rate when the primary reactors are all operating at expected conversions and feed rates. The processes and systems of the present disclosure include one or more supplementary reactors that can be used to either replace a suboptimally-performing primary reactor or to supplement the suboptimally-performing primary reactor. A primary reactor can become suboptimal due to suboptimal performance of the catalyst operating at less than a desired activity or due to the changeover from an old catalyst to a new catalyst in a reactor.

The use of one or more supplemental reactors beyond that which is sufficient to sustain the maximum, permitted rate of the plant when the reactors are operating at expected conversion requires a larger capital cost for the processes and systems of the present disclosure compared to more conventional Andrussow processes and systems. However, the additional capital cost can provide for a more consistent production rate from the multi-reactor system. A more consistent production rate can provide for more consistent operation of other parts of the Andrussow process (such as ammonia recovery, hydrogen cyanide purification, and wastewater treatment, described below), and can provide for more consistent operation for downstream consumers of the hydrogen cyanide produced by the Andrussow process. The use of one or more supplemental reactors can also permit scheduled maintenance rather than rushed catalyst change-out, reducing costs and improving the time that the system is online.

The processes and systems of the present disclosure can be particularly useful in an oxygen-enriched Andrussow process or an oxygen Andrussow process, as compared to an air Andrussow process. An air Andrussow process uses air as the oxygen-containing feed stream, having approximately 20.95 mol % oxygen. An oxygen-enriched Andrussow process uses an oxygen-containing feed stream with an oxygen content that is greater than that found in air, e.g., a feed stream having about 21 mol % oxygen to about 26%, 27%, 28%, 29%, or to about 30 mol % oxygen, such as about 22 mol % oxygen, 23%, 24%, or about 25 mol % oxygen. An oxygen Andrussow process uses an oxygen-containing feed stream having about 26 mol % oxygen, 27%, 28%, 29%, or about 30 mol % oxygen to about 100 mol % oxygen. In some embodiments, an oxygen Andrussow process can use an oxygen-containing feed stream having about 35 mol % oxygen, 40%, 45%, 50%, 55%, 60%, 65%, 70%, 75%, 80%, 85%, 90%, 95%, or about 100 mol % oxygen.

In various examples, the oxygen-containing feed stream in an oxygen-enriched Andrussow process, or in an oxygen Andrussow process with an oxygen-containing feed stream having less than 100 mol % oxygen, can be generated by at least one of mixing air with oxygen, by mixing oxygen with any suitable gas or combination of gases, or by removing one or more gases from an oxygen-containing gas composition such as air.

There are advantages to the use of an oxygen-enriched or oxygen Andrussow process instead of an air Andrussow process. Advantageously, by using an oxygen-enriched or oxygen Andrussow process, a greater proportion of hydrogen can be generated in the effluent stream than in an air Andrussow process. Also, in an oxygen-enriched or oxygen Andrussow process, less non-reactive or impurity materials are present in the oxygen-containing feed stream, which reduces heating costs of the desired reagents prior to adding to a reactor, resulting in reduced energy costs. The equipment for production of an equivalent amount of HCN can also be more compact (smaller) for an oxygen-enriched or oxygen Andrussow process than for an air Andrussow process.

However, an oxygen-enriched Andrussow process or an oxygen Andrussow process can have a number of problems that are not experienced in an air Andrussow process. Moreover, as the oxygen concentration of the feed gas increases, the problems are amplified. For example, the reagents in an oxygen-enriched or oxygen Andrussow process are less diluted by other gases, such as inert gases. Therefore, an oxygen-enriched or oxygen Andrussow process tends to proceed in a more concentrated fashion than an air Andrussow process. As such, an oxygen-enriched or oxygen Andrussow process tends to generate a higher concentration of all products, including byproducts. The larger concentration of products and the smaller reactor size can result in a larger drop in output for the system compared to an air Andrussow process if one of the reactors must be taken offline, such as to change out a catalyst bed.

The more concentrated nature of an oxygen-enriched or oxygen Andrussow process can also cause the reactor and associated equipment to be more susceptible to the build-up of impurities in the system that can more easily be flushed out of the equipment employed in an air Andrussow process. The greater rate of byproduct build-up can lead to increased rates of corrosion as well as more frequent shut down and maintenance of various parts of the process. Equipment that can be significantly affected by byproduct build-up, corrosion and related problems include, for example, the reactor(s), the ammonia recovery system(s), and the HCN recovery system(s). For example, the catalyst in an oxygen-enriched or oxygen Andrussow process generally has to be changed out more frequently than the catalyst in an air Andrussow process.

Other components within the reactors can also be corroded or broken down quicker in an oxygen-enriched or oxygen Andrussow process compared to an air Andrussow process. For example, structures within the reactor that support the catalyst bed or other parts of the reactor, such as heat exchanger piping, can be made of ceramic material that can more quickly corrode or break down in an oxygen-enriched or oxygen Andrussow process as compared to an air Andrussow process.

In addition, because the reagents in an oxygen-enriched or oxygen Andrussow process are more concentrated, the reaction can be more sensitive to variations in concentration of reagents than in an air Andrussow process. Local variations in the concentration of reagents as the reagents travel past the catalyst can cause temperature variations in the catalyst bed, such as hot spots, which can reduce the life of the catalyst as compared to an air Andrussow process. An oxygen-enriched or oxygen Andrussow process can be more sensitive to changes in the heating value of the feed gas; therefore, small variations in the composition of the feed stream can cause greater temperature fluctuations in the reactor than would be observed for similar feed stream compositions in an air Andrussow process. Variations in the concentration or flow rate of reagents in an oxygen-enriched or oxygen Andrussow process can also cause larger differences in the overall efficiency of the process as compared to an air Andrussow process.

Heat transfer from the effluent of an oxygen-enriched or oxygen Andrussow process can be more difficult than in an air Andrussow process, in part because the effluent is more concentrated than observed for an air Andrussow process and cooling such a concentrated effluent to the point of condensation can increase the likelihood of side product formation that might not be observed if the effluent was more dilute.

In an oxygen-enriched or oxygen Andrussow process, additional engineering controls or care can be taken to avoid problems related to the use of pure oxygen or an oxygen-enriched oxygen source, resulting in safety protocols in equipment design and operation that are not generally used or required in an air Andrussow process.

The systems and processes described herein can provide solutions to these problems. For example, the use of one or more supplemental reactors can provide allow the system to respond better to the scenario wherein a reactor or the reactor catalyst needs to be taken offline, which, as described above, occurs more frequently in an oxygen-enriched or oxygen Andrussow process. Because catalyst change-over occurs more quickly with oxygen-enriched and oxygen Andrussow processes, the availability of one or more supplementary reactors allows the system to be operating with reduced or eliminated downtime.

The use of one or more supplementary reactors can also provide more flexibility for an operator to adjust rates to all the reactors, including supplemental, suboptimal, and normally-operating reactors. This flexibility can, in some examples, allow the operator to counteract or remedy some of the problems associated with oxygen-enriched or oxygen Andrussow processes. For example, feed rates or compositions of the reaction mixture to one or more of the reactors can be controlled to counteract the buildup of byproducts or impurities described above. In addition, when using the one or more supplemental reactors along with primary reactors, the feed rates of the reactant feed can be reduced compared to the feed to just the primary reactors. Therefore, the reactors can be operated at more efficient conditions.

As is further described below, the use of one or more supplemental reactors can also provide for a more consistent composition of the effluent streams coming from the HCN synthesis portion of the system, e.g., the use of one or more supplementary reactors can reduce or eliminate composition swings in the effluent stream. This, in turn, can reduce composition swings coming out of subsequent systems of the process, such as the ammonia recovery system. More uniform operation can also provide for more economical operation of downstream systems, such as the ammonia recovery system. Because a portion of the recovered ammonia can be recycled back to the reactors, the use of one or more supplementary reactors can provide for more consistent concentrations of the reactants that are being fed to the reactors. As described above, variations in reagent concentrations in the reactors can lead to temperature variation in the catalyst beds resulting in the formation of hot spots. Thus, the use of one or more supplemental reactors can prolong the life of the catalyst, and can provide for better control over problems that can occur due to the use of pure oxygen or oxygen-enriched feed sources. The more consistent reagent concentration can also improve the overall efficiency of the system. More uniform operation can also balance out the steam production rates from the waste heat boilers on the reactor effluent streams and can simplify steam management for the plant. In other words, it can become unnecessary or less likely to start up and shut down dedicated steam production boilers because the HCN system is more reliably producing a given rate of steam.

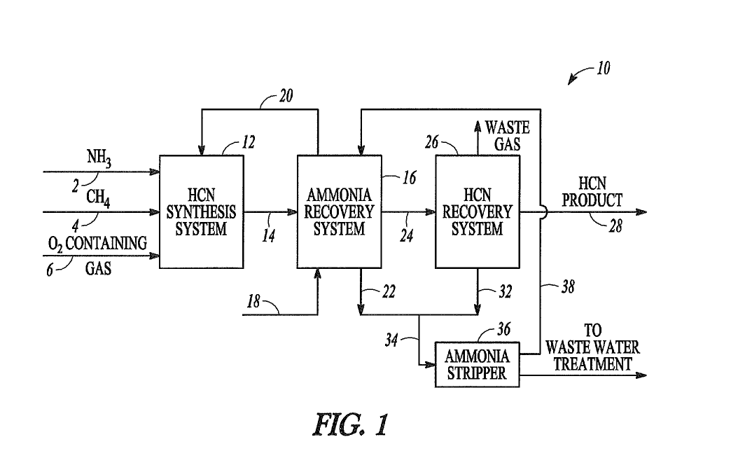

FIG. 1 is a flow diagram of an example process 10 for the production of hydrogen cyanide (HCN) via the Andrussow process. In the example process 10, a HCN synthesis system 12 is supplied with an ammonia (NH₃) stream 2, a methane (CH₄) stream 4, and an oxygen-containing stream 6 (which includes oxygen gas (O₂)). The three feed streams 2, 4, 6, are mixed and reacted in a plurality of reactors (described in more detail below) to be converted to hydrogen cyanide and water in the presence of a suitable catalyst according to Reaction 1:

2NH₃+2CH₄+3O₂→2HCN+6H₂O [1]

The resulting product stream 14 from the HCN synthesis system 12 can be fed into an ammonia recovery system 16 that is configured to recover unreacted NH₃. Ammonia can be recovered by NH₃ absorption via contacting with an acid stream 18 comprising one or more of phosphoric acid (H₃PO₄), sulfuric acid (H₂SO₄), and an ammonium phosphate solution, that can absorb NH₃ from the product stream 14. In the example shown in FIG. 1, the acid stream 18 is added to the ammonia recovery system 16 to absorb NH₃. In the case of an H₃PO₄ solution, ammonia can be removed from the resulting ammonium phosphate solution using one or more strippers to separate the NH₃ from the H₃PO₄. The NH₃ can be recycled back to the HCN synthesis system 12 via an NH₃ recycle stream 20. The ammonia recovery solution and other waste can be recycled or purged as a wastewater stream 22, while an NH₃-stripped HCN stream 24 can be fed to an HCN recovery system 26.

An ammonia absorber can be of any suitable design and can generally operate countercurrently. Acid-rich sorbent liquid can enter the absorber tower near the top and can flow downwardly. The absorber tower can contain internals to facilitate liquid-gas contact. Examples of suitable internals are taught in Kirk-Othmer Encyclopaedia of Chemical Technology, 3^{rd} Edition, vol. 1, pp. 53-96 (John Wiley & Sons, 1978), and can include trays, plates, rings and saddles, merely to name a few. An ammonia-containing gas can enter the tower near the bottom and flow upwardly, contacting the sorbent liquid countercurrently if the liquid is introduced near the top of the column. Gas and liquid flows to the absorber column are regulated to provide for efficient contacting, while flooding the column (due to excessively high liquid charge), entraining liquid in the ammonia-enriched gas (due to excessive flow of gas) or low absorption performance caused by an inadequate flow of gas to the absorption column. The choices of column length, diameter, and type of internal(s) can be determined by one of ordinary skill in the art given the throughput and purity requirements for the ammonia recycle stream.

Any suitable configuration of columns to form an ammonia absorption system can be used, including, for example, one column or multiple column arrangements. Although a single column can provide the necessary contact time between the aqueous solution and the feed stream to effectively remove a desired amount of ammonia, it can sometimes be more convenient to use a plurality of columns in place of one. For example, tall or large columns can be expensive to build, house, and maintain. Any description herein of an ammonia absorber can include any suitable number of columns that together form the ammonia absorber. The ammonia absorber can include an absorber unit and a stripper unit, such as in examples that separate ammonia from an Andrussow process reaction effluent, an HCN stripper unit. In such an example, the absorber unit can extract ammonia from a feed stream using the aqueous solution. The aqueous solution that enters the absorber unit can be an aqueous solution recycle stream from the desorber. The absorber allows the feed stream and the aqueous solution to separate, at least to some extent. The top stream of the absorber unit, which can contain HCN separated from the majority of the ammonia, then can pass to an HCN recovery system. The aqueous solution, which can contain residual feed stream materials including HCN, can then enter the stripper unit, which can heat the aqueous solution. The stripper unit can allow the aqueous solution and other materials to separate, for example residual feed stream materials including residual HCN can be more fully separated from the aqueous solution in the stripper unit. Ammonia absorption can also occur in the stripper unit. The top stream of the stripper unit, which can include residual HCN or other materials, can return to the absorber unit, for example entering with the feed stream. The bottom stream of the stripper unit can then pass to the ammonia desorber.

The HCN recovery system 26 can include one or more unit operations configured to separate and purify HCN from the HCN stream 24. As a result of the HCN recovery system 26, a purified HCN product stream 28 is produced. The HCN recovery system 26 can also produce a waste gas 30 and a wastewater stream 32 that can be optionally combined with the wastewater stream 22 from the ammonia recovery system 16 into a combined wastewater stream 34. The combined wastewater 34 can be fed into an ammonia stripper 36 that can recover additional NH₃ 38 that can be recycled back to the ammonia recovery system 16. The final wastewater 40 from the ammonia stripper 36 can be further processed in a wastewater treatment, storage, or disposal system

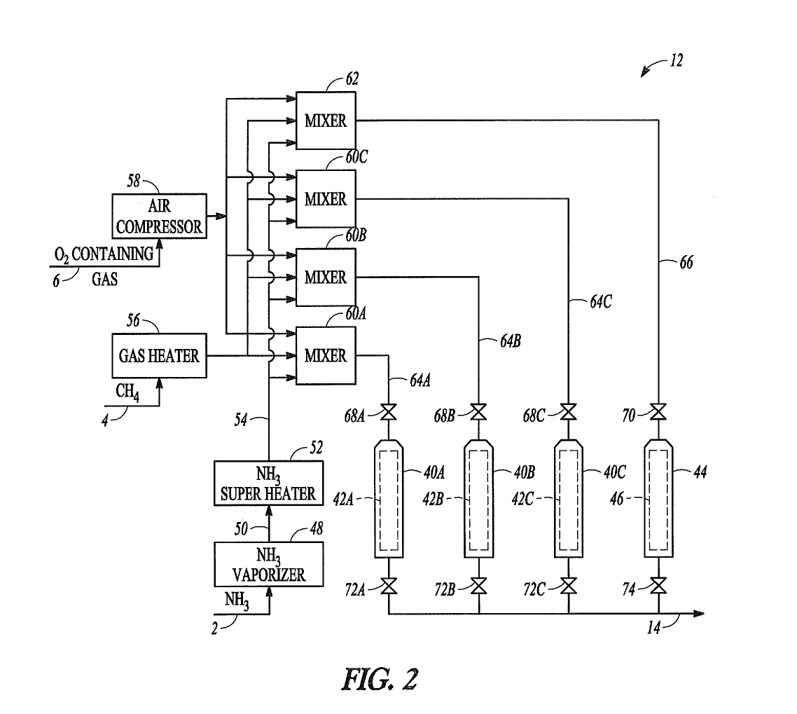

FIG. 2 is a more detailed flow diagram of an example HCN synthesis system 12 that can be used in the process 10 of FIG. 1. The HCN synthesis system 12 includes a plurality of primary reactors 40A, 40B, and 40C (collectively referred to herein as “primary reactor 40” or “primary reactors 40”) each including a catalyst bed 42A, 42B, 42C (collectively referred to herein as “catalyst bed 42” or “catalyst beds 42”), and one or more supplementary reactors 44 including a catalyst bed 46.

Each catalyst bed 42, 46 comprises a catalyst material that is capable of catalyzing Reaction 1, such as a catalyst comprising platinum (Pt) or a platinum alloy. In an example, the catalyst beds 42, 46 each comprise a platinum and rhodium (Rh) catalyst, such as a catalyst comprising from about 85 wt % to about 95 wt % Pt and from about 5 wt % to about 15 wt % Rh. The catalyst of the catalyst beds 42, 46 can also comprise small amounts of metal impurities, such as iron (Fe), palladium (Pd), iridium (Ir), ruthenium (Ru), and other metals. The impurity metals can be present in trace amounts, such as about 10 ppm or less.

The catalyst beds 42, 46 can be formed with the catalyst, such as the Pt—Rh catalyst described above, on a support structure, such as a woven or knitted gauze sheet, a corrugated catalyst structure, or a supported catalyst structure. In an example, the woven or knitted gauze sheet can form a mesh-like structure having a size from 20-80 mesh, e.g., having openings with a size from about 0.18 mm to about 0.85 mm. The amount of catalyst that is present in each catalyst bed 42, 46 can depend on the feed rate of the reaction mixture being feed to each corresponding reactor 40, 44. In an example, the mass of catalyst in each catalyst bed 42, 46 is from about 0.4 g to about 0.6 g per feed rate, in pounds per hour, of the reaction mixture being fed to the reactor 40, 46.

The catalyst of the catalyst beds 42, 46 can be a commercially-available catalyst, such as a Pt—Rh catalyst gauze available from Johnson Matthey Plc, London, UK, or a Pt—Rh catalyst gauze available from Heraeus Precious Metals GmbH & Co., Hanau, GERMANY.

The HCN synthesis system 12 can be configured so that if it is determined that the percent yield of HCN in any of the primary reactors 40 is at or below a desired yield threshold, then the reaction feed can be fed to the one or more supplementary reactors 44 to either replace the suboptimal primary reactor 40 or as a supplement that is operated alongside the suboptimal primary reactor 40. In an example, each of the plurality of primary reactors 40 have substantially identical geometries (e.g., substantially the same dimensions and substantially the same shape). Similarly, each of the one or more supplementary reactors 44 can also have a substantially identical geometry to that of each of the primary reactors 40 so that each of the one or more supplementary reactors 44 can act as a substitute reactor for a primary reactor 40 that is operating suboptimally. The supplementary reactor 44 can then act as one of the primary reactors, and the suboptimal primary reactor 40 that was taken offline can now act as a supplementary reactor.

The HCN synthesis system 12 can include operations for preparing each feed stream, e.g., the NH₃ stream 2, the CH₄ stream 4, and the oxygen-containing stream 6, to be at desired conditions in order to effectuate reaction according to Reaction 1 and to produce HCN. For example, the NH₃ feed stream 2, which can be fed as a liquid, can be vaporized by an ammonia vaporizer 48 that can vaporize the liquid NH₃ stream 2 into an NH₃ vapor stream 50. The NH₃ vapor stream 50 can be further heated in an NH₃ super heater 52 to form a superheated NH₃ vapor 54.

The CH₄ stream 4 can be in the form of a natural gas feed 4. The composition of the natural gas feed 4 can be a majority CH₄ with small percentages of other hydrocarbons. In an example, the natural gas feed 4 can be from about 90 wt % to about 97 wt % CH₄, from about 3 wt % to about 10 wt % ethane (C₂H₆), from about 0 wt % to about 5 wt % propane (C₃H₈), from about 0 wt % to about 1 wt % butane (C₄H₁₀, either in the form of isobutene, n-butane, or a combination thereof), and trace amounts of higher hydrocarbons and other gases. The natural gas feed 4 can also be purified to comprise a more pure source of methane. In an example, a purified natural gas feed 4 can comprise about 99.9% CH₄ and less than about 0.1 wt % other hydrocarbons (which are primarily ethane). The natural gas feed 4 can be heated by a gas heater 56.

The oxygen-containing stream 6 can be pressurized, such as with a compressor 58. As described above, in an example, the oxygen-containing stream 6 can comprise an oxygen-enriched stream, e.g., having an oxygen content of at least 21 mol %, to about 26%, 27%, 28%, 29%, or to about 30 mol % oxygen, such as about 22 mol % oxygen, 23%, 24%, or about 25 mol % oxygen, or an oxygen stream, e.g., having an oxygen content of about 26 mol % oxygen to about 100 mol % oxygen, such as about 35 mol % oxygen, 40%, 45%, 50%, 55%, 60%, 65%, 70%, 75%, 80%, 85%, 90%, 95%, or about 100 mol % oxygen.

The three feed streams 2, 4, 6, can be combined, such as with gas mixture. In an example, a gas mixture 60A, 60B, 60C (collectively referred to herein as “gas mixer 60” or “gas mixers 60”) is provided to feed a reaction mixture feed stream 64A, 64B, 64C (collectively referred to herein as “reaction mixture feed stream 64” or “reaction mixture feed streams 64”) to each of the primary reactors 40 and a gas mixer 62 is provided to feed a reaction mixture feed stream 66 to the supplementary reactor 44. Each gas mixer 60, 62 can be independently controlled in order to control the ratio of each reactant (NH₃, CH₄, and O₂) that is present in each reaction mixture feed stream 64, 66. The mixers 60, 62 can be separate equipment, as shown in FIG. 2, or the mixers can be incorporated into another piece of equipment, such as by being part of the reactors 40, 44.

During normal operation of an oxygen Andrussow process, the reaction mixture feed streams 64, 66 that are fed to the reactors can have a composition of from about 25 mol % to about 40 mol % CH₄, from about 30 mol % to about 45 mol % NH₃, and from about 20 mol % to about 45 mol % O₂; such as from about 28.7 mol % to about 37.1 mol % O₂, from about 34.3 mol % to about 43.8 mol % NH₃, and from about 25.6 mol % to about 30.7 mol % O₂. In an example, the reaction mixture feed streams 64, 66 have a composition of about 33.3 mol % CH₄, about 38.9 mol % NH₃, and about 27.8 mol % O₂. During normal operation of an air or oxygen-enriched Andrussow process, the reaction mixture feed streams 64, 66 the are fed to the reactors can have a composition of about 15-40 vol % CH₄, about 15-45 vol % NH₄, and about 15-70 vol % air or oxygen-enriched air. The reaction mixture feed streams 64, 66 can also include trace amounts of other, reactive or non-reactive compounds such as carbon dioxide (CO₂) and nitrogen gas (N₂). In an example oxygen Andrussow process, the reaction mixture feed streams 64, 66 includes 0 mol % to about 3 mol % CO₂ and 0 mol % to about 2 mol % N₂.

The HCN synthesis system 12 can be configured to determine whether one or more of the primary reactors 40 is operating at a suboptimal rate such that a percent yield of HCN in the one or more primary reactors is at or below a predetermined threshold. Such an underperforming reactor 40 is referred to herein as a “suboptimal reactor.” For the sake of brevity, the remainder of this disclosure will describe an example where the first primary reactor 40A is found to be operating below the predetermined threshold, and the first primary reactor 40A will, therefore, be referred to as the “suboptimal reactor 40A.” However, a person of ordinary skill in the art will understand that any of the primary reactors 40A, 40B, 40C can operate at a suboptimal rate such that any of the primary reactors 40A, 40B, 40C can be a “suboptimal reactor” within the meaning of the present disclosure.

Several parameters can be used to determine if a particular reactor 40 is operating at a suboptimal yield. Examples of parameters that can indicate that the reactor 40A is operating at a suboptimal rate can include, but are not limited to, a pressure drop across the catalyst bed 42A (with a larger pressure drop indicating that the catalyst is performing less efficiently), a composition of the reactor product gas (which can be determined using a gas chromatograph or other compositional analysis device), a temperature of the catalyst bed 42A (with a lower temperature indicating that the catalyst is performing less efficiently), a ratio of the feed rate of the reaction mixture to a particular reactor compared to the feed rate to other reactors after the feed rates have been adjusted to maintain a desired yield, and the age of the catalyst in the catalyst bed 42A (that is, the amount of time that the catalyst has been in operation) compared to an expected lifetime of the catalyst. In an example, an increase of methane concentration in the effluent stream from the reactor 40A can trigger a finding that the reactor 40A is operating suboptimally, also referred to herein as a “methane breakthrough.” A methane breakthough can be determined to occur when the methane concentration in the effluent of the reactor 40A is greater than or equal to a threshold value. In an example, the methane breakthrough threshold can be about 0.4 mol % to about 1 mol %, such as about 0.6 mol %.

A decrease in the overall yields of all the reactors 40 can also be used to indicate that one of the primary reactors 40A potentially is operating at a suboptimal rate. In an example, the ammonia yield (e.g., the percentage of the moles of ammonia fed to the HCN synthesis system 12 from the NH₃ stream 2 that is converted to HCN) can be used to determine if the reactor 40A is operating suboptimally. As shown by Reaction 1 above, ideally each mole of NH₃ that is fed to the reactors 40 are converted to a mole of HCN. Therefore, the NH₃ yield of each reactor 40 can be defined as the moles of HCN produced in the reactor 40 divided by the moles of NH₃ fed to the reactor 40. As described above, a portion of the NH₃ fed to the reactor is recycled from the NH₃ recovery system 16 is recycled back to the HCN synthesis system 12 so that a portion of the NH₃ fed to each reactor is recycled NH₃. In an example, the NH₃ yield for each reactor 40 can be determined based on the new NH₃ fed to the reactor 40 (e.g., not including the recycled NH₃). An initial decrease in overall yield can sometimes be remedied by adjusting the feed ratio between the reactors 40. This is generally a short-term solution, however, and eventually the yield will continue to decline, sometimes more rapidly, and eventually cannot be improved by adjusting the feed ratio.

In an example, a decrease of from about 5% to about 10% of an expected or desired yield can indicate that one of the primary reactors 40 is operating at a suboptimal rate. After a finding that the overall yield has decreased by this amount, each of the individual primary reactors 40 can be investigated to isolate the suboptimal reactor 40A from the other reactors 40B, 40C that can be operating normally. Various parameters can be measured or determined, such as one or more of the pressure drop across each catalyst bed 42, the temperature of each catalyst bed 42, and the input and output compositions for each reactor 40. If the measuring or determining of these parameters indicates that one of the primary reactors 40 is operating at a suboptimal rate, such as the first primary reactor 40A, then the suboptimal reactor 40A can be replaced with the supplementary reactor 44 (as described below). If the measuring and determining of these parameters indicate that all of the primary reactors 40 are operating at a suboptimal rate, then it may be inferred that likely some other aspect of the process other than the reactors 40 is operating improperly, because it would be unusual for all of the primary reactors 40 would operate suboptimally in the same way at the same time.

As indicated above, the HCN synthesis system 12 includes at least one supplementary reactor 44 that can be used to supplement the primary reactors 40 if one or more of the primary reactors 40 are determined to be operating at a percent yield that is less than a minimum desired threshold. In order to facilitate the use of the one or more supplementary reactors 44, the HCN synthesis system 12 can include a plurality of primary inlet valves 68A, 68B, 68C (collectively referred to herein as “primary inlet valve 68” or “primary inlet valves 68”) that can each be controlled to reduce or close off a reaction mixture feed stream 64 to a corresponding primary reactor 40 if the corresponding primary reactor 40 is determined to be operating at a suboptimal rate. A supplementary inlet valve 70 can be included to open up the supplementary reactor mixture feed stream 66 into the supplementary reactor 44. The HCN synthesis system 12 can also include a plurality of primary outlet valves 72A, 72B, 72C (collectively referred to herein as “primary outlet valve 72” or “primary outlet valves 72”) each corresponding to one of the primary reactors 40, and a supplementary outlet valve 74. The outlet valves 72, 74 can be operated so that an offline reactor 40, 44 will be isolated from the product stream 14.

The HCN synthesis system 12 can include a control system 76 that can control the flow rate of each reaction mixture feed stream 64, 66 to its corresponding reactor 40, 44. For example, the control system 76 can reduce or cease the reaction mixture feed stream 64A that is fed to the first primary reactor 40A if it is determined that the first reactor 40A is operating at a suboptimal yield. The control system 76 can also initiate feeding of the reaction mixture feed stream 66 to the supplemental reactor 44. If desired, the control system 76 can control the mixers 60, 62 in order to control the composition in each reaction mixture feed stream 64, 66 that is fed to each reactor 40, 44. In an example, the control system can control the mixers 60, 62, the primary inlet valves 68, the supplementary inlet valve 70, the primary outlet valves 72, and the supplementary outlet valve 74 in order to allow or prevent the reaction mixture to pass into the desired combination of reactors 40, 44. The valves 68, 70, 72, 74 can be controlled by the control system 76 that is configured to initiate feeding of the reaction mixture to the supplementary reactor 44, such as by opening the supplementary inlet valve 70 and the supplementary outlet valve 74, and discontinue the reaction mixture feed to the suboptimal primary reactor or reactors 40, such as by closing one of the primary inlet valves 68 and a corresponding primary outlet valve 72. The control system 76 and valves 68, 70, 72, 74 can be configured so that the valve 68, 70, 72, 74 are movable between an open position and a closed position. Alternatively, the control system 76 and each of the valves 68, 70, 72, 74 can be configured to be movable between one or more intermediate positions in addition to the open and closed position so that one or more of the valves 68, 70, 72, 74 can also control a flow rate through the valves 68, 70, 72, 74 in order to split the flow of the reaction mixture between a particular primary reactor 40 and a supplementary reactor 44.

The control system 76 can also be configured to determine whether a percent yield of HCN in any of the primary reactors 40 is below a threshold or to identify which of the primary reactors 40 are operating at a suboptimal percent yield. The control system 76 can also maintain an overall HCN production rate from the remaining primary reactors 40 and the one or more supplementary reactors 44 within a desired overall HCN production rate range. The control system 76 is described in more detail below.

For example, if it is determined that the first primary reactor 40A is operating at a suboptimal level (e.g., because the catalyst bed 42A is operating at a suboptimal conversion) and it is desired to replace the suboptimal first primary reactor 40A with the supplementary reactor 44, than the reaction mixture in the reaction mixture feed stream 64A can be diverted through a first bypass line 66A by closing a first primary reactor inlet valve 68A and opening the supplementary reactor inlet valve 70. If it is desired to supplement the first primary reactor 40A with the supplementary reactor 44, than a portion of the reaction mixture can be diverted from the first primary reaction 40A to the supplementary reactor 44 by partially closing the first primary reactor inlet valve 68A and partially opening the first supplementary reactor inlet valve 70A. In an example, the reaction mixture feed streams 64, 66 can be controlled to be fed to any combination of the primary reactors 40 and the one or more supplementary reactors 44, and in some examples, with any combination of feed rates, in order to fully supplement any suboptimal primary reactors 40 in order to provide for an overall HCN production rate that is within a desired overall HCN production rate range.

In an example, the suboptimal reactor 40A can be shut down by first turning off the oxygen being fed to the reactor 40A from the air feed stream 6, e.g., by closing a valve from the air feed 6 to the mixer 60A or the reactor 40A. After ceasing oxygen flow, the reactor 40A can be purged by the other reactant streams (e.g., NH₃ stream 2 and methane stream 4), for a predetermined period of time before turning off the remaining reactant feed streams 2 and 4. After ceasing the NH₃ feed stream 2 and the methane feed stream 4, the effluent from the reactor 40A can be sent to a flare to flare off any products or reactants that are not desired to be vented. Then the reactor 40A can be flushed with an inert gas stream, such as nitrogen.

After determining that one or more of the primary reactors is a suboptimal rector 40A, a changeover procedure can be initiated to start up operation of the supplementary reactor 44 and to shut down operation of the suboptimal reactor 40A. An initial step in the changeover procedure can be to start up the supplementary reactor 44, such as by opening the supplementary inlet valve 70 and/or the supplementary outlet valve 74. The flow rate of the reaction mixture to the supplementary reactor 44 can be controlled during the start up and initial operation of the supplementary reactor.

In an example, the catalyst in the catalyst bed 46 of the supplementary reactor 44 is not activated prior to start up of the supplementary reactor 44. Therefore, in an example, the catalyst bed 46 can be activated during an initial period of time immediately after start up of the supplementary reactor 44. Activation of the catalyst bed 46 can include first lighting the reactor, which can take from 0 hours to about 6 hours, or longer, followed by running the supplementary reactor 44 with a reaction mixture that is different from the final reaction mixture. In an example, the activating reaction mixture can have a low amount of CH₄ compared to the final reaction mixture. While feeding the reactor 44 with a low-CH₄ reaction mixture, the reactor 44 can be operated at an elevated temperature relative to the normal operation of the reactor 44 after the catalyst bed 46 has been activated. The supplementary reactor 44 can be run at this elevated temperature for about 8 hours to about 10 days in order to fully activate the catalyst 46 and allow the reactor 44 to operate at full rate. After activating the catalyst bed 46, the ratio of the reaction mixture can be changed to the normal reactant ratio, and the feed rate to the supplementary reactor 44 can be gradually increased over a period of time, such as for about 12 hours to about 4 days.

After starting up the supplementary reactor 44, the flow rate of the reaction mixture to the suboptimal reactor 40A can be reduced or shut down. The output rate of all the reactors, e.g., all the primary reactors 40 (including the suboptimal reactor 40A) and the supplemental reactor 44, can be monitored and the flow rate of the reaction mixture fed to the suboptimal reactor 40A and the supplemental reactor 44 can be adjusted to maintain a desired output for the entire process 10. For example, the flow rate to the supplementary reactor 44 can be kept at a minimum rate for a predetermined period of time in order to minimize the impact to downstream operations in the ammonia recovery system 16, and the HCN recovery system 26. Depending on the total yield, the suboptimal reactor 40A and the supplemental reactor 44 can both be operated with a reaction mixture feed for a period of time before fully shutting down the suboptimal reactor 40A.

In some examples, the supplemental reactor 44 can only be used to augment the suboptimal reactor 40A so that all of the primary reactors 40, including the suboptimal reactor 40A, and the supplemental reactor 44 can be operated indefinitely, for example until a planned shut down can be initiated. In an example, the suboptimal reactor 40A and the supplemental reactor 44 can be operated concurrently for several days up to several weeks. The amount of time when the suboptimal reactor 40A and the supplemental reactor 46 are operated concurrently can depend greatly on the particular situation and conditions.

During the changeover from the suboptimal reactor 40A to the supplemental reactor 44, there can be a period of time where there are swings in the overall production rate of HCN from the process 10. For example, as the supplemental reactor 44 is being started up and the feed rate of the reaction mixture to the suboptimal reactor 40A is being reduced or shut down, there can be a swing of about 10% to about 20% in the overall production rate of HCN from all of the primary reactors 40 and the supplementary reactor 44, either as an increase or a decrease in the production rate. This swing can continue while feed rates to each of the primary reactors 40 and the supplementary reactor 44 are being adjusted and, if desired, while the suboptimal reactor 40A is being shut down. In an example, the swings in production rates during the changeover can continue for from a few minutes (e.g., 5-10 minutes) to about 6 hours, or longer, until feed rates and other operating parameters are adjusted and the overall production rate can be stabilized.

After the suboptimal reactor 40A has been shut down, the spent catalyst bed 42A can be replaced and the new catalyst bed 42A can be activated so that the suboptimal reactor 40A can be ready to be used as a new supplementary reactor. In other words, the normally-operating primary reactors 40B and 40C and the newly operational supplementary reactor 44 can act as the primary reactors, and the shut down suboptimal reactor 40A with a newly activated catalyst bed 42A can act as a supplemental reactor to replace one of the operating primary reactors 40B, 40C, 44, should one of those reactors 40B, 40C, 44 begin to operate at a suboptimal yield.

The catalyst bed 42A of the suboptimal reactor 40A can be removed by first isolating the suboptimal reactor 40A from the system, such as by closing the first inlet valve 68A and/o the first outlet valve 72A. After isolating the suboptimal reactor 40A, a flow of reactant can continue to be fed to the suboptimal reactor 40A, followed by cutting off the oxygen (air) flow while keeping NH₃ and CH₄ flowing for a predetermine period of time, for example from about 10 minutes to about 15 minutes. The NH₃ and CH₄ flow can then be ceased, and the suboptimal reactor 40A can be flushed with a non-reactive gas, such as nitrogen (N₂) for a predetermined period, such as about 15 minutes. The suboptimal reactor 40A can be allowed to cool, if needed, the reactor 40A can be opened, and the spent catalyst bed 42A can be removed. A new catalyst bed 42A can be installed in the reactor 40A so that it can be ready to act as a supplementary reactor, as described above.

### EXAMPLES

The present disclosure can be better understood by reference to the following examples which are offered by way of illustration. The present disclosure is not limited to the examples given herein.

### Comparative Example 1

### Normal Operation

A 4 inch internal diameter stainless steel reactor with ceramic insulation lining inside is used for pilot scale test. Forty sheets of 90 wt % Pt/10 wt % Rh 40 mesh gauze from Johnson Matthey (USA) are loaded as catalyst bed. Perforated alumina tile is used for catalyst sheet support. The total flow rate is set at 2532 SCFH (standard cubic foot per hour). In a simulated manufacturing sequence, three reactors are used in an Andrussow reaction facility to generate hydrogen cyanide from a reaction mixture of about 34 mol % methane, about 37 mol % ammonia, and about 27 mol % oxygen in the presence of a platinum or a platinum alloy catalyst. The gaseous product stream from the reactors contains about 17 mol % hydrogen cyanide, about 6 mol % unreacted ammonia, about 35 mol % hydrogen, about 6 mol % CO, and about 34 mol % H₂O, with an approximately about 82% overall yield of hydrogen cyanide based on NH₃ reacted (mole based).

The performance of the reactors is monitored by determining the overall yield of hydrogen cyanide. When the overall yield decreases by about 3% (e.g., to about 79% based on NH₃ reacted (mole based)), then it may be assumed that one of the three reactors are operating at a suboptimal yield. It can be determined which reactor is operating at a suboptimal yield by determining at least one of: the pressure drop across the catalyst bed of each reactor, the temperature of each reactor bed, and the inlet and outlet compositions for each reactor. The suboptimal reactor can be shut down until the catalyst bed can be replaced and the new catalyst bed can be activated. During that time, the facility will continue to operate with only two reactors such that the facility operates at approximately two-thirds (67%) of desired capacity and with an overall yield of about 82% based on NH₃ reacted (mole based).

### Example 2

### Supplementary Reactor Replaces Suboptimal Primary Reactor

A 4 inch internal diameter stainless steel reactor with ceramic insulation lining inside is used for pilot scale test. Forty sheets of 90 wt % Pt/10 wt % Rh 40 mesh gauze from Johnson Matthey (USA) are loaded as catalyst bed. Perforated alumina tile is used for catalyst sheet support. The total flow rate is set at 2532 SCFH (standard cubic foot per hour). In a manufacturing sequence, hydrogen cyanide is produced from three primary reactors, similar to the configuration described in Comparative Example 1. The facility of Example 2 also includes a supplemental reactor. The performance of the primary reactors is monitored by determining the overall yield of hydrogen cyanide. The lower limit for an optimal yield in this Example is 3% lower than normal based on NH₃. One of the three primary reactors is detected to have a suboptimal gaseous product stream including greater than 0.6 mol % unreacted methane. The gaseous product stream from the suboptimal reactor can result in a 10% reduction in hydrogen cyanide and a 10% reduction in unreacted ammonia, resulting in a reduction of the yield of that particular reactor of approximately 10% based on NH₃ reacted (mole based). The suboptimal reactor decreases the overall yield of the three reactors by about 3%. The suboptimal performance of one of the reactors, as opposed to other aspect of the facility, is confirmed by measuring at least one of the pressure drop across the catalyst bed of each primary reactor, the temperature of the catalyst bed of each primary reactor, and the inlet and outlet compositions of each primary reactor.

The supplementary reactor is started up by feeding a reaction mixture feed at a minimum feed rate to the supplementary reactor to activate the catalyst of the supplementary reactor. During an initial period of time, such as about 6 hours to about 24 hours, for example about 8 hours, the reaction mixture fed to the supplementary reactor can have a composition that is different from that of the reaction mixture fed to the primary reactors. For example, the reaction mixture fed to the supplementary reactor during start up and catalyst activation can be about 4% more methane, about 3% less ammonia, and about 1% less oxygen. Even after this initial period of time, when the same feed composition as the primary reactors can be fed to the supplementary reactor, the feed rate and composition fed to the supplementary reactor may be adjusted for about 2 days to about 10 days before the supplementary reactor can be run at full capacity.

After the supplementary reactor catalyst is activated, the suboptimal primary reactor is shut down by ceasing the reaction mixture feed to the suboptimal primary reactor. During start up of the supplementary reactor and shut down of the supplementary reactor, the feed rate to both the supplementary reactor and the suboptimal reactor can be adjusted to minimize downstream effects to the remainder of the facility. After being shut down, the suboptimal reactor can be given a catalyst change. With the supplementary reactor online, and the suboptimal reactor offline, the overall production rate of HCN can remain within about 10% of the desired overall production rate during changeover to the supplemental reactor, and after changeover the overall production rate can be brought back up to 100% of the desired capacity, compared to the 67% of desired capacity that can be achieved during shut down of the suboptimal reactor in Comparative Example 1. After changeover, the overall yield of the supplementary reactor is about 5% less than the optimal primary reactors based on NH₃ reacted.

### Example 3

### Supplementary Reactor Operates Concurrently with Suboptimal Primary Reactor

A 4 inch internal diameter stainless steel reactor with ceramic insulation lining inside is used for pilot scale test. Forty sheets of 90 wt % Pt/10 wt % Rh 40 mesh gauze from Johnson Matthey (USA) are loaded as catalyst bed. Perforated alumina tile is used for catalyst sheet support. The total flow rate is set at 2532 SCFH (standard cubic foot per hour). In a manufacturing sequence, a hydrogen cyanide production facility includes three primary reactors and one supplementary reactor, similar to the configured described in Example 2. The performance of the primary reactors is monitored by determining the overall yield of hydrogen cyanide. The lower limit for an optimal yield in this Example is 3% lower than normal based on NH₃. One of the three primary reactors is detected to have a suboptimal gaseous product stream including greater than 0.6 mol % unreacted methane. The gaseous product stream from the suboptimal reactor can result in a 10% reduction in hydrogen cyanide and a 10% reduction in unreacted ammonia, resulting in reduction in for that particular reactor of approximately 10% based on NH₃. The suboptimal reactor decreases the overall yield of the three reactors by about 3%. The suboptimal performance of one of the reactors, as opposed to other aspect of the facility, is confirmed by measuring the pressure drop across the catalyst bed of each primary reactor, the temperature of the catalyst bed of each primary reactor, and the inlet and outlet compositions of each primary reactor. For example, a pressure drop across a primary reactor that is equal to or greater than 110% of the pressure drop across the normally-operating primary reactors can indicate that the higher-pressure drop reactor is operating suboptimally.

The supplementary reactor is started up by feeding a reaction mixture feed at a minimum feed rate to the supplementary reactor to activate the catalyst of the supplementary reactor. During an initial period of time, such as about 6 hours to about 24 hours, for example about 8 hours, the reaction mixture fed to the supplementary reactor can have a composition that is different from that of the reaction mixture fed to the primary reactors. For example, the reaction mixture fed to the supplementary reactor during start up and catalyst activation can be about 4% more methane, about 3% less ammonia, and about 1% less oxygen. Even after this initial period of time, when the same feed composition as the primary reactors can be fed to the supplementary reactor, the feed rate and composition fed to the supplementary reactor may be adjusted for about 2 days to about 10 days before the supplementary reactor can be run at full capacity. The feed rate to the suboptimal reactor is also reduced to a minimum feed rate. After the supplementary reactor catalyst is activated, the feed rates to the supplemental reactor, to the suboptimal primary reactor, and to the normally-operating primary reactors are adjusted to optimize the overall HCN production rate and the overall yield of HCN. The composition of the reaction mixture fed to each type of reactor can also be adjusted.

With the supplementary reactor and the suboptimal reactor operating concurrently, the overall production rate of HCN can remain within about 10% of the desired overall production rate during the startup of the supplemental reactor and the activation of the catalyst in the supplemental reactor. After changeover, the overall production rate can be approximately 100% of the desired capacity, compared to the 67% of desired capacity that can be achieved during shut down of the suboptimal reactor in Comparative Example 1.

As the suboptimal reactor continues to produce a lower and lower yield of HCN, the feed rate of the reaction mixture to the supplemental reactor is slowly increased to maintain the overall yield within about 3% of the normal yield based on reacted NH₃. Once the yield of the supplementary reactor increases to within about 5% of the optimal primary reactors based on reacted NH₃, the suboptimal reactor is taken offline for a catalyst change and other maintenance.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary embodiments, workers skilled in the art will recognize that changes may be made in form and detail without departing from the spirit and scope of the invention.

Specific enumerated statements provided below are for illustration purposes only, and do not otherwise limit the scope of the disclosed subject matter, as defined by the claims. These enumerated statements encompass all combinations, sub-combinations, and multiply referenced (e.g., multiply dependent) combinations described therein.

### Statements

Statement 1 provides a process for the production of hydrogen cyanide, the process comprising:

feeding a reaction mixture feed to a plurality of primary reactors each comprising a catalyst bed comprising platinum or a platinum alloy, the reaction mixture feed comprising gaseous ammonia, methane, and oxygen gas;

determining whether a percent yield of hydrogen cyanide in any of the plurality of primary reactors is at or below a threshold;

identifying one or more suboptimal reactors amongst the plurality of primary reactors when the percent yield of hydrogen cyanide in any of the plurality of primary reactors is at or below the threshold;

supplementally feeding the reaction mixture feed to one or more supplementary reactors when the one or more suboptimal reactors are identified, wherein each of the one or more supplementary reactors comprises a catalyst bed comprising platinum or a platinum alloy;

upon commencing the supplementally feeding, discontinuing the reaction mixture feed to the one or more suboptimal reactors;

wherein the determining, the supplementally feeding, and the discontinuing are sufficient to maintain an overall measured hydrogen cyanide production rate amongst the one or more supplementary reactors and the primary reactors, other than the one or more suboptimal reactors, that is within a desired overall hydrogen cyanide production rate range.

Statement 2 provides the process of Statement 1, wherein the determining, the supplementally feeding, and the discontinuing are sufficient to maintain an overall measured hydrogen cyanide percent yield amongst the one or more supplementary reactors and the primary reactors, other than the one or more suboptimal reactors, that is within a desired overall hydrogen cyanide percent yield rate range.

Statement 3 provides the process of either one of Statements 1 or 2, wherein the identifying the one or more suboptimal reactors comprises at least one of determining a composition of an effluent from each of the plurality of primary reactors, determining an ammonia yield of each of the plurality of primary reactors, determining a yield to hydrogen cyanide of each of the plurality of primary reactors, and determining a pressure drop across each of the plurality of primary reactors

Statement 4 provides the process of Statement 3, wherein determining the composition of the effluent comprises determining a methane concentration of the effluent of each of the plurality of primary reactors, wherein the identifying the one or more primary reactors comprises determining that the methane concentration of the effluent is equal to or greater than a methane breakthrough threshold.

Statement 5 provides the process of Statement 4, wherein the methane breakthrough threshold is 0.4 mol % to 1 mol % methane.

Statement 6 provides the process of any one of Statements 1-5, further comprising monitoring the percent yield of hydrogen cyanide in each of the plurality of primary reactors, in each of the one or more supplementary reactors, or a combination thereof.

Statement 7 provides the process of any one of Statements 1-6, wherein determining whether the percent yield of hydrogen cyanide in any of the plurality of primary reactors or any of the supplementary reactors is at or below the threshold comprises comparing percent yields of hydrogen cyanide of each of the primary reactors or the supplementary reactors to the threshold.

Statement 8 provides the process of any one of Statements 1-7, wherein the plurality of primary reactors is capable of providing a desired overall hydrogen cyanide production rate when the primary reactors are each operating with a percent yield of hydrogen cyanide greater than or equal to the threshold.

Statement 9 provides the process of Statement 8, wherein the plurality of primary reactors and the one or more supplementary reactors, when combined, are capable of providing at least the desired hydrogen cyanide production rate after discontinuing the reaction mixture feed to the one or more suboptimal reactors.

Statement 10 provides the process of any one of Statements 1-9, further comprising maintaining the reaction mixture feed to the primary reactors other than the one or more suboptimal reactors upon discontinuing the reaction mixture feed to the one or more suboptimal reactors.

Statement 11 provides the process of any one of Statements 1-10, further comprising activating a catalyst bed of each of the one or more supplementary reactors upon identifying the one or more suboptimal reactors amongst the plurality of primary reactors.

Statement 12 provides the process of Statement 11, wherein the feeding of the reaction mixture feed to the one or more supplementary reactors occurs after activating the catalyst bed of the one or more supplementary reactors.

Statement 13 provides the process of any one of Statements 1-12, further comprising: upon discontinuing the reaction mixture feed to the one or more suboptimal reactors, replacing the catalyst bed of each of the one or more suboptimal reactors with a replacement catalyst bed to produce one or more refurbished reactors; and feeding the reaction mixture feed to the one or more refurbished reactors.

Statement 14 provides the process of Statement 13, further comprising activating the replacement catalyst bed of each of the one or more refurbished reactors prior to feeding the portion of the reaction mixture feed to the one or more refurbished reactors.

Statement 15 provides the process of any one of Statements 13-14, wherein the reaction mixture feed being fed to the one or more refurbished reactors comprises the reaction feed being fed to the one or more supplemental reactors.

Statement 16 provides the process of Statement 15, further comprising discontinuing the reaction mixture feed to the one or more supplemental reactors upon commencing feeding of the reaction mixture feed to the one or more refurbished reactors.

Statement 17 provides the process of any one of Statements 13-16, further comprising maintaining the reaction mixture feed to the one or more refurbished reactors and the one or more supplementary reactors upon feeding the reaction mixture feed to the one or more refurbished reactors.

Statement 18 provides the process of any one of Statements 1-17, further comprising controlling the primary reactors other than the one or more suboptimal reactors and the one or more supplementary reactors to maintain the overall measured hydrogen cyanide production rate in the one or more supplementary reactors and the primary reactors other than the one or more suboptimal reactors within the desired overall hydrogen cyanide production rate range.

Statement 19 provides the process of any one of Statements 1-18, wherein the feeding the reaction mixture feed to a plurality of primary reactors comprises feeding the reaction mixture feed in parallel to each of the plurality of primary reactors.

Statement 20 provides the process of any one of Statements 1-19, wherein the feeding the reaction mixture feed to the one or more supplementary reactors comprises feeding the reaction mixture feed in parallel to the reaction mixture feed to the primary reactors other than the first one of the plurality of primary reactors.

Statement 21 provides the process of any one of Statements 1-20, wherein the reaction mixture feed comprises oxygen-enriched air.

Statement 22 provides the process of any one of Statements 1-21, further comprising recovering hydrogen from an effluent of one or more of the primary reactors and the one or more supplementary reactors.

Statement 23 provides the process of any one of Statements 1-22, wherein the catalyst bed of each of the primary reactors comprises a platinum-rhodium alloy.

Statement 24 provides the process of any one of Statements 1-23, wherein the catalyst bed of each of the one or more supplementary reactors comprises a platinum-rhodium alloy.

Statement 25 provides a system for the production of hydrogen cyanide, the system comprising:

a plurality of primary reactors each comprising a catalyst bed comprising platinum or a platinum alloy, wherein the plurality of primary reactors is capable of providing for a first hydrogen cyanide production rate;

one or more supplemental reactors each comprising a catalyst bed comprising platinum or a platinum alloy;

a feed system for feeding a reaction mixture feed to one or more reactors at a rate sufficient to provide for the first hydrogen cyanide production rate, the reaction mixture feed comprising gaseous ammonia, methane, and oxygen gas;

a control system configured to;
determine whether a percent yield of hydrogen cyanide in any of the plurality of primary reactors is below a threshold,
identify one or more suboptimal reactors with a percent yield of hydrogen cyanide below the threshold,
initiate supplemental feeding of the reaction mixture feed to the one or more supplemental reactors,
discontinue the reaction mixture feed to the one or more suboptimal reactors, and
   maintain an overall measured hydrogen cyanide production rate in the one or more supplementary reactors and the primary reactors other than the one or more suboptimal reactors within a desired overall hydrogen cyanide production rate range.

Statement 26 provides the system of Statement 25, wherein the plurality of primary reactors and the one or more supplementary reactors, when combined, are capable of providing for a second hydrogen cyanide production rate that is greater than the first hydrogen cyanide production rate.

Statement 27 provides the system of any one of Statements 25-26, wherein the control system is further configured to maintain the reaction mixture feed to the primary reactors other than the one or more suboptimal reactors upon discontinuing the reaction mixture feed to the first one of the plurality of primary reactors.

Statement 28 provides the system of any one of Statements 25-27, wherein the control system is further configured to initiate activation of the catalyst bed of the one or more supplementary reactors upon determining that the percent yield of hydrogen cyanide of the one or more suboptimal reactors is at or below the threshold.

Statement 29 provides the system of any one of Statements 25-28, wherein the control system is further configured to monitor a percent yield of hydrogen cyanide in each of the plurality of primary reactors, in each of the one or more supplementary reactors, or a combination thereof.

Statement 30 provides the system of any one of Statements 25-29, wherein the control system is further configured to compare the percent yield of hydrogen cyanide of each of the plurality of primary reactors or each of the one or more supplementary reactors to the threshold.

Statement 31 provides the system of any one of Statements 25-30, wherein the reaction mixture feed comprises oxygen-enriched air.

Statement 32 provides the system of any one of Statements 25-31, further comprising a hydrogen recovery system for recovering hydrogen from an effluent of one or more of the primary reactors and the one or more supplementary reactors.

Statement 33 provides the system of any one of Statements 25-32, wherein the catalyst bed of each of the primary reactors comprises a platinum-rhodium alloy.

Statement 34 provides the system of any one of Statements 25-33, wherein the catalyst bed of each of the one or more supplementary reactors comprises a platinum-rhodium alloy.

Statement 35 provides a process for the production of hydrogen cyanide, the process comprising:

feeding a reaction mixture feed to a plurality of primary reactors each comprising a catalyst bed comprising platinum or a platinum alloy, the reaction mixture feed comprising gaseous ammonia, methane, and oxygen gas;

determining whether a percent yield of hydrogen cyanide in any of the plurality of primary reactors is at or below a threshold;

identifying one or more suboptimal reactors amongst the plurality of primary reactors when the percent yield of hydrogen cyanide in any of the plurality of primary reactors is at or below the threshold;

feeding the reaction mixture feed to one or more supplementary reactors each comprising a catalyst bed comprising platinum or a platinum alloy;

wherein the supplemental feeding is sufficient to maintain an overall measured hydrogen cyanide production rate in the one or more supplementary reactors and the plurality of primary reactors that is within a desired overall hydrogen cyanide production rate range.

Statement 36 provides the process of Statement 35, wherein the supplemental feeding is sufficient to maintain an overall measured hydrogen cyanide percent yield in the one or more supplementary reactors and the plurality of primary reactors that is within a desired overall hydrogen cyanide percent yield range.

Statement 37 provides the process of any one of Statements 35-36, wherein the one or more supplementary reactors supplement conversion of the reaction mixture feed to hydrogen cyanide by the plurality of primary reactors so that the overall measured hydrogen cyanide production rate in the one or more supplementary reactors and the plurality of primary reactors is within the desired overall hydrogen cyanide production rate.

Statement 38 provides the process of any one of Statements 35-37, further comprising maintaining the reaction mixture feed to the one or more suboptimal reactors or reducing the reaction mixture feed to the one or more suboptimal reactors.

Statement 39 provides the process of any one of Statements 35-38, further comprising maintaining the reaction mixture feed to the primary reactors other than the one or more suboptimal reactors while feeding the reaction mixture feed to the one or more supplementary reactors.

Statement 40 provides the process of any one of Statements 35-39, further comprising replacing the catalyst bed of each of the one or more suboptimal reactors with a replacement catalyst bed to produce one or more refurbished reactors.

Statement 41 provides the process of Statement 40, further comprising activating the replacement catalyst bed.

Statement 42 provides the process of any one of Statements 40-41, further comprising feeding the reaction mixture feed to the one or more refurbished reactors.

Statement 43 provides the process of any one of Statements 40-42, further comprising discontinuing the portion of the reaction mixture feed to the one or more supplemental reactors upon commencing feeding of the portion of the reaction mixture feed to the one or more refurbished reactors.

Statement 44 provides the process of any one of Statements 40-43, further comprising maintaining the reaction mixture feed to the one or more refurbished reactors and the one or more supplementary reactors upon feeding the reaction mixture feed to the one or more refurbished reactors.

Statement 45 provides the process of any one of Statements 35-44, wherein the plurality of primary reactors is capable of providing for a desired overall hydrogen cyanide production rate when the primary reactors are each operating with a percent yield of hydrogen cyanide greater than or equal to the threshold.

Statement 46 provides the process of any one of Statements 35-45, wherein the plurality of primary reactors and the one or more supplementary reactors, when combined, are capable of providing at least the desired hydrogen cyanide production rate.

Statement 47 provides the process of any one of Statements 35-56, further comprising activating the catalyst bed of each of the one or more supplementary reactors upon identifying the one or more suboptimal reactors amongst the plurality of primary reactors.

Statement 48 provides the process of Statement 47, wherein the feeding of the reaction mixture feed to the one or more supplementary reactors occurs after activating the catalyst bed of each of the one or more supplementary reactors.

Statement 49 provides the process of any one of Statements 35-48, further comprising controlling the plurality of primary reactors and the one or more supplementary reactors to maintain the overall measured hydrogen cyanide production rate in the one or more supplementary reactors and the plurality of primary reactors within the desired overall hydrogen cyanide production rate range.

Statement 50 provides the process of any one of Statements 35-49, further comprising monitoring the percent yield of hydrogen cyanide in each of the plurality of primary reactors, in each of the one or more supplementary reactors, or a combination thereof.

Statement 51 provides the process of any one of Statements 35-50, wherein determining whether the percent yield of hydrogen cyanide in any of the plurality of primary reactors or any of the supplementary reactors is at or below the threshold comprises comparing the percent yield of hydrogen cyanide of each of the plurality of primary reactors or the supplementary reactors to the threshold.

Statement 52 provides the process of any one of Statements 35-51, wherein the feeding the reaction mixture feed to a plurality of primary reactors comprises feeding the reaction mixture feed in parallel to each of the plurality of primary reactors.

Statement 53 provides the process of any one of Statements 35-52, wherein the feeding the reaction mixture feed to the one or more supplementary reactors comprises feeding the reaction mixture feed in parallel to the reaction mixture feed to the plurality of primary reactors.

Statement 54 provides the process of any one of Statements 35-53, wherein the reaction mixture feed comprises oxygen-enriched air.

Statement 55 provides the process of any one of Statements 35-54, further comprising recovering hydrogen from an effluent of one or more of the primary reactors and the one or more supplementary reactors.

Statement 56 provides the process of any one of Statements 35-55, wherein the catalyst bed of each of the primary reactors comprises a platinum-rhodium alloy.

Statement 57 provides the process of any one of Statements 35-56, wherein the catalyst bed of each of the one or more supplementary reactors comprises a platinum-rhodium alloy.

Statement 58 provides a system for the production of hydrogen cyanide, the system comprising:

a plurality of primary reactors each comprising a catalyst bed comprising platinum or a platinum alloy, wherein the plurality of primary reactors are capable of providing for a first hydrogen cyanide production rate;

one or more supplemental reactors each comprising a catalyst bed comprising platinum or a platinum alloy;

a feed system for feeding a reaction mixture feed to one or more reactors at a rate sufficient to provide for the first hydrogen cyanide production rate, the reaction mixture feed comprising gaseous ammonia, methane, and oxygen gas;

a control system configured to;
determine whether a percent yield of hydrogen cyanide in any of the plurality of primary reactors is below a threshold,
identify one or more suboptimal reactors amongst the plurality of primary reactors with a percent yield of hydrogen cyanide below the threshold,
initiate supplemental feeding of the reaction mixture feed to the one or more supplemental reactors, and
maintain an overall measured hydrogen cyanide production rate in the plurality of primary reactors and the one or more supplementary reactors within a desired overall hydrogen cyanide production rate range.

Statement 59 provides the system of Statement 58, wherein the plurality of primary reactors and the one or more supplementary reactors, when combined, are capable of providing for a second hydrogen cyanide production rate that is greater than the first production rate.

Statement 60 provides the system of any one of Statements 58-59, wherein the control system is further configured to initiate activation of the catalyst bed of the one or more supplementary reactors.

Statement 61 provides the system of any one of Statements 58-60, wherein the control system is further configured to maintain the reaction mixture feed to the one or more suboptimal reactors or to reduce the reaction mixture feed to the one or more suboptimal reactors.

Statement 62 provides the system of any one of Statements 58-61, wherein the control system is further configured to maintain the reaction mixture feed to the primary reactors other than the one or more suboptimal reactors while feeding the reaction mixture feed to the one or more supplementary reactors.

Statement 63 provides the system of any one of Statements 58-62, wherein the control system is further configured to monitor the percent yield of hydrogen cyanide in each of the plurality of primary reactors, in each of the one or more supplementary reactors, or a combination thereof.

Statement 64 provides the system of any one of Statements 58-63, wherein the control system is further configured to compare the percent yield of hydrogen cyanide of each of the plurality of primary reactors or each of the one or more supplementary reactors to the threshold.

Statement 65 provides the system of any one of Statements 58-64, wherein the reaction mixture feed comprises oxygen-enriched air.

Statement 66 provides the system of any one of Statements 58-65, further comprising a hydrogen recovery system for recovering hydrogen from an effluent of one or more of the primary reactors and the one or more supplementary reactors.

Statement 67 provides the system of any one of Statements 58-66, wherein the catalyst bed of each of the primary reactors comprises a platinum-rhodium alloy.

Statement 68 provides the system of any one of Statements 58-67, wherein the catalyst bed of each of the one or more supplementary reactors comprises a platinum-rhodium alloy.

Statement 69 provides the apparatus or method of any one or any combination of Statements 1-68 optionally configured such that all elements or options recited are available to use or select from.

1. A process for the production of hydrogen cyanide, the process comprising:
feeding a reaction mixture feed to a plurality of primary reactors each comprising a catalyst bed comprising platinum or a platinum alloy, the reaction mixture feed comprising gaseous ammonia, methane, and oxygen gas;
determining whether a percent yield of hydrogen cyanide in any of the plurality of primary reactors is at or below a threshold;
identifying one or more suboptimal reactors amongst the plurality of primary reactors when the percent yield of hydrogen cyanide in any of the plurality of primary reactors is at or below the threshold;
supplementally feeding the reaction mixture feed to one or more supplementary reactors when the one or more suboptimal reactors are identified, wherein each of the one or more supplementary reactors comprises a catalyst bed comprising platinum or a platinum alloy;
upon commencing the supplementally feeding, discontinuing the reaction mixture feed to the one or more suboptimal reactors;
wherein the determining, the supplementally feeding, and the discontinuing are sufficient to maintain an overall measured hydrogen cyanide production rate amongst the one or more supplementary reactors and the primary reactors, other than the one or more suboptimal reactors, that is within a desired overall hydrogen cyanide production rate range.

2. The process of claim 1, wherein the determining, the supplementally feeding, and the discontinuing are sufficient to maintain an overall measured hydrogen cyanide percent yield amongst the one or more supplementary reactors and the primary reactors, other than the one or more suboptimal reactors, that is within a desired overall hydrogen cyanide percent yield rate range.

3. The process of claim 1, wherein the identifying the one or more suboptimal reactors comprises at least one of determining a composition of an effluent from each of the plurality of primary reactors, determining an ammonia yield of each of the plurality of primary reactors, determining a yield to hydrogen cyanide of each of the plurality of primary reactors, and determining a pressure drop across each of the plurality of primary reactors.

4. The process of claim 3, wherein determining the composition of the effluent comprises determining a methane concentration of the effluent of each of the plurality of primary reactors, wherein the identifying the one or more primary reactors comprises determining that the methane concentration of the effluent is equal to or greater than a methane breakthrough threshold.

5. The process of claim 4, wherein the methane breakthrough threshold is 0.4 mol % to 1 mol % methane.

6. The process of claim 1, further comprising monitoring the percent yield of hydrogen cyanide in each of the plurality of primary reactors, in each of the one or more supplementary reactors, or a combination thereof.

7. The process of claim 1, wherein determining whether the percent yield of hydrogen cyanide in any of the plurality of primary reactors or any of the supplementary reactors is at or below the threshold comprises comparing percent yields of hydrogen cyanide of each of the primary reactors or the supplementary reactors to the threshold.

8. The process of claim 1, wherein the plurality of primary reactors is capable of providing a desired overall hydrogen cyanide production rate when the primary reactors are each operating with a percent yield of hydrogen cyanide greater than or equal to the threshold.

9. The process of claim 8, wherein the plurality of primary reactors and the one or more supplementary reactors, when combined, are capable of providing at least the desired hydrogen cyanide production rate after discontinuing the reaction mixture feed to the one or more suboptimal reactors.

10. The process of claim 1, further comprising maintaining the reaction mixture feed to the primary reactors other than the one or more suboptimal reactors upon discontinuing the reaction mixture feed to the one or more suboptimal reactors.

11. The process of claim 1, further comprising activating a catalyst bed of each of the one or more supplementary reactors upon identifying the one or more suboptimal reactors amongst the plurality of primary reactors.

12. The process of claim 11, wherein the feeding of the reaction mixture feed to the one or more supplementary reactors occurs after activating the catalyst bed of the one or more supplementary reactors.

13. The process of claim 1, further comprising:
upon discontinuing the reaction mixture feed to the one or more suboptimal reactors, replacing the catalyst bed of each of the one or more suboptimal reactors with a replacement catalyst bed to produce one or more refurbished reactors; and
feeding the reaction mixture feed to the one or more refurbished reactors.

14. The process of claim 13, further comprising activating the replacement catalyst bed of each of the one or more refurbished reactors prior to feeding the portion of the reaction mixture feed to the one or more refurbished reactors.

15. The process of claim 13, wherein the reaction mixture feed being fed to the one or more refurbished reactors comprises the reaction feed being fed to the one or more supplemental reactors.

16. The process of claim 15, further comprising discontinuing the reaction mixture feed to the one or more supplemental reactors upon commencing feeding of the reaction mixture feed to the one or more refurbished reactors.

17. The process of claim 13, further comprising maintaining the reaction mixture feed to the one or more refurbished reactors and the one or more supplementary reactors upon feeding the reaction mixture feed to the one or more refurbished reactors.

18. The process of claim 1, further comprising controlling the primary reactors other than the one or more suboptimal reactors and the one or more supplementary reactors to maintain the overall measured hydrogen cyanide production rate in the one or more supplementary reactors and the primary reactors other than the one or more suboptimal reactors within the desired overall hydrogen cyanide production rate range.

19. The process of claim 1, wherein the feeding the reaction mixture feed to a plurality of primary reactors comprises feeding the reaction mixture feed in parallel to each of the plurality of primary reactors.

20. The process of claim 1, wherein the feeding the reaction mixture feed to the one or more supplementary reactors comprises feeding the reaction mixture feed in parallel to the reaction mixture feed to the primary reactors other than the first one of the plurality of primary reactors.

21. The process of claim 1, wherein the reaction mixture feed comprises oxygen-enriched air.

22. The process of claim 1, further comprising recovering hydrogen from an effluent of one or more of the primary reactors and the one or more supplementary reactors.

23. The process of claim 1, wherein the catalyst bed of each of the primary reactors comprises a platinum-rhodium alloy.

24. The process of claim 1, wherein the catalyst bed of each of the one or more supplementary reactors comprises a platinum-rhodium alloy.

25.-68. (canceled)
